(19) United States
(12) Patent Application Publication
(10) Pub. No.: US 2019/0357305 A1
(43) Pub. Date: Nov. 21, 2019

(54) METHOD FOR IMPLEMENTING USER EQUIPMENT COOPERATION AND APPARATUS

(71) Applicant: HUAWEI TECHNOLOGIES CO., LTD., SHENZHEN (CN)

(72) Inventors: Hongjia SU, Shanghai (CN); Jiyong PANG, Shanghai (CN); Zhengzheng XIANG, Shanghai (CN)

(21) Appl. No.: 16/529,498

(22) Filed: Aug. 1, 2019

Related U.S. Application Data
(63) Continuation of application No. PCT/CN2018/072772, filed on Jan. 16, 2018.

(30) Foreign Application Priority Data
Feb. 28, 2017 (CN) 201710114330.7

(51) Int. Cl. H04W 88/04; H04B 7/26; H04L 5/00; H04W 72/04; H04W 72/08; H04W 72/12

(52) U.S. Cl. CPC H04W 88/04; H04B 7/26; H04L 5/0055; H04W 72/1289; H04W 72/0446; H04W 72/08; H04W 72/1268; H04W 72/042

(57) ABSTRACT

A method for implementing user equipment cooperation is provided. The method includes: generating, by an access network device, cooperative control information, where the cooperative control information is used to instruct first user equipment to perform sidelink transmission in a first transmission unit of a first subframe and perform uplink transmission in a second transmission unit of the first subframe, the first transmission unit is adjacent to the second transmission unit, and the sidelink transmission includes that the first user equipment sends feedback information to second user equipment and that the second user equipment receives the feedback information sent by the first user equipment; and sending, by the access network device, the cooperative control information to the first user equipment and the second user equipment. According to this application, the access network device can control a plurality of user equipments to perform user equipment cooperation.

### CROSS-REFERENCE TO RELATED APPLICATIONS

This application is a continuation of International Application No. PCT/CN2018/072772, filed on Jan. 16, 2018, which claims priority to Chinese Patent Application No. 201710114330.7, filed on Feb. 28, 2017. The disclosures of the aforementioned applications are hereby incorporated by reference in their entireties.

### TECHNICAL FIELD

This application relates to the field of communication technologies, and in particular, to a method for implementing user equipment cooperation and an apparatus.

### BACKGROUND

In a wireless communications network, some users have relatively low network quality of service and relatively poor user experience, because the users are located at an edge of a network coverage area, or interference of a surrounding environment to a network service is relatively high, or the like. A user equipment cooperation mechanism is introduced. To be specific, when some users are located in a central area of the network coverage area or have a relatively good surrounding network environment, if these users can help the users having poor network quality of service perform cooperative communication, different users may exchange some information with each other by using a sidelink (SL) communication technology, to greatly improve network quality of the users that have poor network quality of service before. For an entire system, network quality of service can be improved as a whole, to further obtain larger system throughput.

FIG. 1 is a schematic flowchart of user equipment cooperation. A procedure mainly includes the following operations. Operation 1: A 5th generation (5G) base station (gNodeB, gNB) sends downlink data to a user equipment cooperation group (UECG) in a multicast manner (where group members include: cooperating user equipment (CUE) 1, CUE 2, and target user equipment (TUE) 1). The members in the cooperation group receive the downlink data. The CUE 1 and/or the CUE 2 correctly decode/decodes the downlink data, but the TUE 1 fails to correctly decode the downlink data. Operation 2: The CUE 1 and/or the CUE 2 send/sends first cooperative data to the TUE 1, where content of the first cooperative data is the same as that of the downlink data. Operation 3: The TUE 1 fails to correctly decode the first cooperative data, and the TUE 1 feeds back a negative acknowledgement (NACK) to the CUE 1 and the CUE 2. Operation 4: The CUE 1 and the CUE 2 receive the NACK feedback from the TUE 1, and send second cooperative data, where content of the second cooperative data is the same as that of the first cooperative data, and the second cooperative data is a retransmission version of the first cooperative data. Operation 5: The TUE 1 correctly decodes the second cooperative data, and feeds back an acknowledgement (ACK) to the gNB. Although a concept of user equipment cooperation has been provided, a specific implementation in which the gNB controls a plurality of user equipments to perform user equipment cooperation is not provided currently. Therefore, how the gNB controls the plurality of user equipments to perform the user equipment cooperation is a currently discussed technical problem.

### SUMMARY

Embodiments of the present invention provide a method for implementing user equipment cooperation and an apparatus, so that an access network device can control a plurality of user equipments to perform user equipment cooperation.

According to a first aspect, an embodiment of the present invention provides a method for implementing user equipment cooperation. The method is applied to an access network device side. The method includes: generating, by an access network device, cooperative control information, where the cooperative control information is used to instruct first user equipment to perform sidelink transmission in a first transmission unit of a first subframe and perform uplink transmission in a second transmission unit of the first subframe, the first transmission unit is adjacent to the second transmission unit, the sidelink transmission includes that the first user equipment sends feedback information to second user equipment and that the second user equipment receives the feedback information sent by the first user equipment; and sending, by the access network device, the cooperative control information to the first user equipment and the second user equipment. According to this embodiment of the present invention, efficiency of performing user equipment cooperation by the first user equipment and the second user equipment that are controlled by the access network device can be improved.

In one embodiment, the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, and the fourth transmission unit is prior to the first transmission unit.

In one embodiment, the sending, by the access network device, the cooperative control information to the first user equipment and the second user equipment includes: sending, by the access network device, the cooperative control information to the first user equipment and the second user equipment in a fifth transmission unit of the first subframe, where the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, the fourth transmission unit is prior to the first transmission unit, and the fifth transmission unit is prior to the third transmission unit.

In one embodiment, the sending, by the access network device, the cooperative control information to the first user equipment and the second user equipment includes: sending, by the access network device, the cooperative control information to the first user equipment and the second user equipment in a fifth transmission unit of the first subframe, where the cooperative control information is further used to instruct the second user equipment to send sidelink data to the first user equipment in a fourth transmission unit of the first subframe, the fourth transmission unit is prior to the first transmission unit, and the fifth transmission unit is prior to the fourth transmission unit.

According to a second aspect, an embodiment of the present invention provides a method for implementing user equipment cooperation. The method is applied to a first user equipment side. The method includes: receiving, by first user equipment, cooperative control information sent by an access network device; and performing, by the first user equipment based on the cooperative control information, sidelink transmission in a first transmission unit of a first subframe and uplink transmission in a second transmission unit of the first subframe, where the first transmission unit is adjacent to the second transmission unit, and the sidelink transmission includes that the first user equipment sends feedback information to second user equipment. According to this embodiment of the present invention, efficiency of performing user equipment cooperation by the first user equipment and the second user equipment that are controlled by the access network device can be improved.

In one embodiment, before the performing, by the first user equipment based on the cooperative control information, sidelink transmission in a first transmission unit of a first subframe and uplink transmission in a second transmission unit of the first subframe, the method further includes: receiving, by the first user equipment in a third transmission unit of the first subframe based on the cooperative control information, control information corresponding to sidelink data, and receiving the sidelink data in a fourth transmission unit of the first subframe based on the control information, where the third transmission unit is adjacent to the fourth transmission unit, the third transmission unit is prior to the fourth transmission unit, and the fourth transmission unit is prior to the first transmission unit

In one embodiment, the receiving, by first user equipment, cooperative control information sent by an access network device includes: receiving, by the first user equipment in a fifth transmission unit of the first subframe, the cooperative control information sent by the access network device; and before the performing, by the first user equipment based on the cooperative control information, sidelink transmission in a first transmission unit of a first subframe and uplink transmission in a second transmission unit of the first subframe, the method further includes: receiving, by the first user equipment in a third transmission unit of the first subframe based on the cooperative control information, control information corresponding to sidelink data, and receiving the sidelink data in a fourth transmission unit of the first subframe based on the control information, where the third transmission unit is adjacent to the fourth transmission unit, the third transmission unit is prior to the fourth transmission unit, the fourth transmission unit is prior to the first transmission unit, and the fifth transmission unit is prior to the third transmission unit.

In one embodiment, the receiving, by first user equipment, cooperative control information sent by an access network device includes: receiving, by the first user equipment in a fifth transmission unit of the first subframe, the cooperative control information sent by the access network device; and before the performing, by the first user equipment based on the cooperative control information, sidelink transmission in a first transmission unit of a first subframe and uplink transmission in a second transmission unit of the first subframe, the method further includes: sending, by the second user equipment, sidelink data to the first user equipment in a fourth transmission unit of the first subframe based on the cooperative control information, where the fourth transmission unit is prior to the first transmission unit, and the fifth transmission unit is prior to the fourth transmission unit.

According to a third aspect, an embodiment of the present invention provides a method for implementing user equipment cooperation. The method is applied to a second user equipment side. The method includes: receiving, by second user equipment, cooperative control information sent by an access network device; and sending, by the second user equipment, sidelink data to first user equipment in a fourth transmission unit of a first subframe based on the cooperative control information, where a first transmission unit in the first subframe is used by the first user equipment to perform sidelink transmission, a second transmission unit in the first subframe is used by the first user equipment to perform uplink transmission, the first transmission unit is adjacent to the second transmission unit, and the fourth transmission unit is prior to the first transmission unit. According to this embodiment of the present invention, efficiency of performing user equipment cooperation by the first user equipment and the second user equipment that are controlled by the access network device can be improved.

In one embodiment, before the sending, by the second user equipment, sidelink data to first user equipment in a fourth transmission unit of a first subframe based on the cooperative control information, the method further includes: sending, by the second user equipment to the first user equipment in a third transmission unit of the first subframe based on the cooperative control information, control information of the sidelink data, where the third transmission unit is adjacent to the fourth transmission unit, and the third transmission unit is prior to the fourth transmission unit.

In one embodiment, the receiving, by second user equipment, cooperative control information sent by an access network device includes: receiving, by the second user equipment in a fifth transmission unit of the first subframe, the cooperative control information sent by the access network device; and before the sending, by the second user equipment, sidelink data to first user equipment in a fourth transmission unit of a first subframe based on the cooperative control information, the method further includes: sending, by the second user equipment to the first user equipment in a third transmission unit of the first subframe based on the cooperative control information, control information of the sidelink data, where the third transmission unit is adjacent to the fourth transmission unit, the third transmission unit is prior to the fourth transmission unit, and the fifth transmission unit is prior to the third transmission unit.

In one embodiment, the receiving, by second user equipment, cooperative control information sent by an access network device includes: receiving, by the second user equipment in a fifth transmission unit of the first subframe, the cooperative control information sent by the access network device, where the fifth transmission unit is prior to the fourth transmission unit.

According to a fourth aspect, an embodiment of the present invention provides a method for implementing user equipment cooperation. The method is applied to an access network device side. The method includes: generating, by an access network device, cooperative control information, where the cooperative control information is used to instruct first user equipment and second user equipment to perform user equipment cooperation, so that the first user equipment performs sidelink transmission in a first transmission unit of a first subframe, and the first user equipment performs uplink transmission in a second transmission unit of the first subframe, where the first transmission unit is adjacent to the second transmission unit, and the sidelink transmission includes that the first user equipment sends feedback information to the second user equipment. According to this embodiment of the present invention, efficiency of performing user equipment cooperation by the first user equipment and the second user equipment that are controlled by the access network device can be improved.

In one embodiment, after the access network device generates the cooperative control information, the second user equipment sends, to the first user equipment in a third transmission unit of the first subframe, control information corresponding to sidelink data, and sends the sidelink data to the first user equipment in a fourth transmission unit of the first subframe, where the third transmission unit is adjacent to the fourth transmission unit, the third transmission unit is prior to the fourth transmission unit, and the fourth transmission unit is prior to the first transmission unit.

In one embodiment, after the access network device generates the cooperative control information, the second user equipment sends, to the first user equipment in a third transmission unit of the first subframe, control information corresponding to sidelink data, and sends the sidelink data to the first user equipment in a fourth transmission unit of the first subframe, where the third transmission unit is adjacent to the fourth transmission unit, the third transmission unit is prior to the fourth transmission unit, the fourth transmission unit is prior to the first transmission unit, and a fifth transmission unit is prior to the third transmission unit.

In one embodiment, after the access network device generates the cooperative control information, the second user equipment sends sidelink data to the first user equipment in a fourth transmission unit of the first subframe, where the fourth transmission unit is prior to the first transmission unit, and a fifth transmission unit is prior to the fourth transmission unit.

According to a fifth aspect, an embodiment of the present invention provides a method for implementing user equipment cooperation. The method is applied to a first user equipment side. The method includes: receiving, by first user equipment, cooperative control information sent by an access network device, where the cooperative control information is used to instruct the first user equipment and second user equipment to perform user equipment cooperation, so that the first user equipment performs sidelink transmission in a first transmission unit of a first subframe, and performs uplink transmission in a second transmission unit of the first subframe, where the first transmission unit is adjacent to the second transmission unit, and the sidelink transmission includes that the first user equipment sends feedback information to the second user equipment. According to this embodiment of the present invention, efficiency of performing user equipment cooperation by the first user equipment and the second user equipment that are controlled by the access network device can be improved.

In one embodiment, before the first user equipment performs the sidelink transmission in the first transmission unit of the first subframe, and performs the uplink transmission in the second transmission unit of the first subframe, the method further includes: receiving, by the first user equipment in a third transmission unit of the first subframe, control information corresponding to sidelink data, and receiving the sidelink data in a fourth transmission unit of the first subframe based on the control information, where the third transmission unit is adjacent to the fourth transmission unit, the third transmission unit is prior to the fourth transmission unit, and the fourth transmission unit is prior to the first transmission unit.

In one embodiment, before the first user equipment performs the sidelink transmission in the first transmission unit of the first subframe, and performs the uplink transmission in the second transmission unit of the first subframe, the method further includes: receiving, by the first user equipment in a third transmission unit of the first subframe, control information corresponding to sidelink data, and receiving the sidelink data in a fourth transmission unit of the first subframe based on the control information, where the third transmission unit is adjacent to the fourth transmission unit, the third transmission unit is prior to the fourth transmission unit, the fourth transmission unit is prior to the first transmission unit, and a fifth transmission unit is prior to the third transmission unit.

In one embodiment, before the first user equipment performs the sidelink transmission in the first transmission unit of the first subframe, and performs the uplink transmission in the second transmission unit of the first subframe, the method further includes: sending, by the second user equipment, sidelink data to the first user equipment in a fourth transmission unit of the first subframe, where the fourth transmission unit is prior to the first transmission unit, and a fifth transmission unit is prior to the fourth transmission unit.

According to a sixth aspect, an embodiment of the present invention provides a method for implementing user equipment cooperation. The method is applied to a second user equipment side. The method includes: receiving, by second user equipment, cooperative control information sent by an access network device, where the cooperative control information used to instruct the second user equipment and first user equipment to perform user equipment cooperation; and sending, by the second user equipment, sidelink data to the first user equipment in a fourth transmission unit of a first subframe, where a first transmission unit in the first subframe is used by the first user equipment to perform sidelink transmission, a second transmission unit in the first subframe is used by the first user equipment to perform uplink transmission, the first transmission unit is adjacent to the second transmission unit, and the fourth transmission unit is prior to the first transmission unit. According to this embodiment of the present invention, efficiency of performing user equipment cooperation by the first user equipment and the second user equipment that are controlled by the access network device can be improved.

In one embodiment, before the sending, by the second user equipment, sidelink data to the first user equipment in a fourth transmission unit of a first subframe based on the cooperative control information, the method further includes: sending, by the second user equipment to the first user equipment in a third transmission unit of the first subframe, control information of the sidelink data, where the third transmission unit is adjacent to the fourth transmission unit, and the third transmission unit is prior to the fourth transmission unit.

In one embodiment, before the sending, by the second user equipment, sidelink data to the first user equipment in a fourth transmission unit of a first subframe based on the cooperative control information, the method further includes: sending, by the second user equipment to the first user equipment in a third transmission unit of the first subframe, control information of the sidelink data, where the third transmission unit is adjacent to the fourth transmission unit, the third transmission unit is prior to the fourth transmission unit, and a fifth transmission unit is prior to the third transmission unit.

According to a seventh aspect, an access network device is provided. The access network device may include: a processor, a transmitter, and a memory. The memory is configured to store a program and data. The processor invokes the program in the memory to perform the method for implementing user equipment cooperation that is described in the first aspect or the fourth aspect.

According to an eighth aspect, user equipment is provided. The user equipment is first user equipment. The first user equipment may include: a processor, a transmitter, and a memory. The memory is configured to store a program and data. The processor invokes the program in the memory to perform the method for implementing user equipment cooperation that is described in the second aspect or the fifth aspect.

According to a ninth aspect, user equipment is provided. The user equipment is second user equipment. The second user equipment may include: a processor, a transmitter, and a memory. The memory is configured to store a program and data. The processor invokes the program in the memory to perform the method for implementing user equipment cooperation that is described in the third aspect or the sixth aspect.

According to a tenth aspect, an access network device is provided. The access network device may include a functional unit or module that is configured to perform the method for implementing user equipment cooperation that is described in the first aspect or the fourth aspect.

According to an eleventh aspect, user equipment is provided. The user equipment is first user equipment. The first user equipment may include a functional unit or module that is configured to perform the method for implementing user equipment cooperation that is described in the second aspect or the fifth aspect.

According to a twelfth aspect, user equipment is provided. The user equipment is second user equipment. The second user equipment may include a functional unit or module that is configured to perform the method for implementing user equipment cooperation that is described in the third aspect or the sixth aspect.

According to a thirteenth aspect, a communications system is provided, including: an access network device, first user equipment, and second user equipment. The access network device may be the access network device described in the seventh aspect or the tenth aspect, the first user equipment may be the first user equipment described in the eighth aspect or the eleventh aspect, and the second user equipment may be the second user equipment described in the ninth aspect or the twelfth aspect.

According to a fourteenth aspect, an embodiment of the present invention provides a computer storage medium, configured to store a computer software instruction used by the foregoing access network device. The computer software instruction includes a program designed for the access network device to implement the first aspect or the fourth aspect.

According to a fifteenth aspect, an embodiment of the present invention provides a computer storage medium, configured to store a computer software instruction used by the foregoing first user equipment. The computer software instruction includes a program designed for the first user equipment to implement the second aspect or the fifth aspect.

According to a sixteenth aspect, an embodiment of the present invention provides a computer storage medium, configured to store a computer software instruction used by the foregoing second user equipment. The computer software instruction includes a program designed for the second user equipment to implement the third aspect or the sixth aspect.

In one embodiment, a first protection unit exits between the first transmission unit and the second transmission unit. The first protection unit is used to provide protection for sending and receiving processing performed by the first user equipment.

In one embodiment, a second protection unit exists between the third transmission unit and the fifth transmission unit. The second protection unit is used to provide protection for sending and receiving processing performed by the second user equipment.

In one embodiment, a third protection unit exists between the fourth transmission unit and the fifth transmission unit. The third protection unit is used to provide protection for sending and receiving processing performed by the second user equipment.

In one embodiment, the second transmission unit is a last transmission unit of the first subframe.

According to the embodiments of the present invention, efficiency of performing user equipment cooperation by the first user equipment and the second user equipment that are controlled by the access network device can be improved. In different user equipment cooperation manners, a corresponding first subframe format is designed, and the first user equipment and the second user equipment may complete a user equipment cooperation process by using first subframes in different formats.

These aspects or other aspects of this application are clearer and more comprehensible in descriptions of the following embodiments.

### BRIEF DESCRIPTION OF DRAWINGS

FIG. 1 is a schematic flowchart of a user equipment cooperation method according to an embodiment of the present invention;

FIG. 2 is a schematic architectural diagram of a communications system according to an embodiment of the present invention;

FIG. 3 is a schematic structural diagram of a first subframe according to an embodiment of the present invention;

FIG. 4 is a schematic structural diagram of another first subframe according to an embodiment of the present invention;

FIG. 5 is a schematic structural diagram of another first subframe according to an embodiment of the present invention;

FIG. 6 is a schematic structural diagram of another first subframe according to an embodiment of the present invention;

FIG. 7 is a schematic flowchart of a user equipment cooperation method according to an embodiment of the present invention;

FIG. 8 is a time-domain diagram of a user equipment cooperation method according to an embodiment of the present invention;

FIG. 9 is a schematic flowchart of another user equipment cooperation method according to an embodiment of the present invention;

FIG. 10 is a time-domain diagram of another user equipment cooperation method according to an embodiment of the present invention;

FIG. 11 is a schematic flowchart of another user equipment cooperation method according to an embodiment of the present invention;

FIG. 12 is a time-domain diagram of another user equipment cooperation method according to an embodiment of the present invention;

FIG. 13A is a schematic structural diagram of a network device according to an embodiment of the present invention; and

FIG. 13B is a schematic structural diagram of another network device according to an embodiment of the present invention.

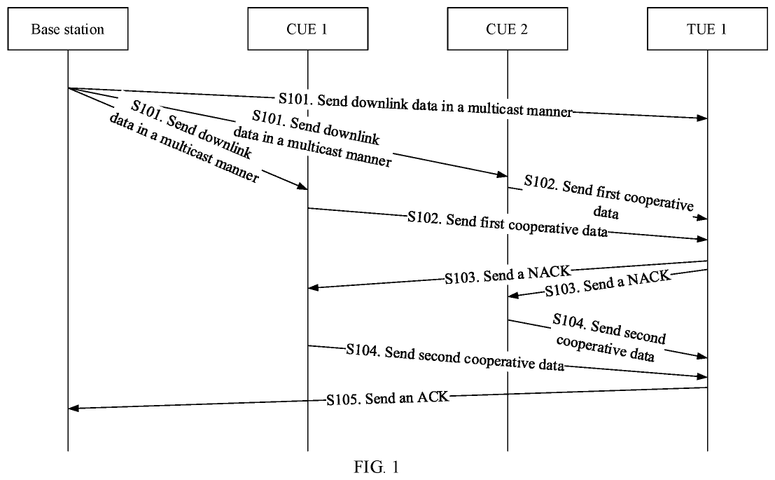

### DESCRIPTION OF EMBODIMENTS

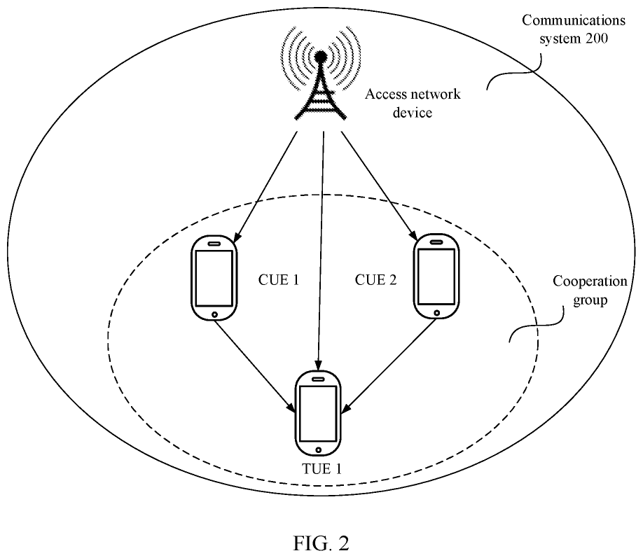

FIG. 2 shows a communications system 200 according to an embodiment of the present invention. The communications system 200 shown in FIG. 2 includes an access network device and a plurality of user equipments. The plurality of user equipments include: CUE 1, CUE 2, and TUE 1. The CUE 1, the CUE 2, and the TUE 1 form a cooperation group. In the cooperation group, the CUE 1 and the CUE 2 can help the TUE 1 perform cooperative communication. During specific implementation, the CUE 1, the CUE 2, and the TUE 1 may form the cooperation group after configuration performed by the access network device, or the CUE 1, the CUE 2, and the TUE 1 form the cooperation group after negotiation through sidelink communication interaction therebetween. The cooperation group corresponds to a cooperation group identifier (CGID). The CGID is configured by the access network device and is notified to all members in the cooperation group, namely, the CUE 1, the CUE 2, and the TUE 1. The cooperation group identifier is unique to at least one cell. In addition, the cooperation group identifier may not be explicitly defined or explicitly allocated by the access network device to a user. Instead, an identifier of the TUE 1 is directly used. To be specific, after detecting the identifier of the TUE 1, the CUE 1 and the CUE 2 may receive, after determining, downlink data sent by the access network device to the TUE 1, to perform user equipment cooperative transmission.

For example, in an application scenario, some users have relatively low network quality of service and relatively poor user experience, because the TUE 1 is located at an edge of a network coverage area, or interference of a surrounding environment to a network service is relatively high. The CUE 1 and the CUE 2 are located in a central area of the network coverage area, or a surrounding network environment of the CUE 1 and the CUE 2 is relatively good, so that the CUE 1 and the CUE 2 can help the TUE 1 with relatively poor network quality perform cooperative communication. The CUE 1 and the TUE 1, and the CUE 2 and the TUE 1 may exchange some information by using a sidelink communication technology, to improve the network quality of the TUE 1. For example, the access network device sends downlink data in a multicast manner by using the cooperation group identifier, and a final destination address of the downlink data is the TUE 1. The CUE 1, the CUE 2, and the TUE 1 decode the downlink data by using the cooperation group identifier. When the TUE 1 cannot correctly receive the downlink data, the CUE 1 and/or the CUE 2 may forward the received downlink data from the access network device to the TUE 1, thereby greatly increasing a probability that the TUE 1 can correctly decode the downlink data.

In this embodiment of the present invention, the CUE 1 (or the CUE 2) and the TUE 1 may perform in-band user equipment cooperation. In other words, the CUE 1 (or the CUE 2) and the TUE 1 perform user equipment cooperation within a serving frequency band of the access network device. Alternatively, the CUE 1 (or the CUE 2) and the TUE 1 may perform out-of-band user equipment cooperation. In other words, the CUE 1 (or the CUE 2) and the TUE 1 do not perform user equipment cooperation within a serving frequency band of the access network device. For example, the CUE 1 (or the CUE 2) and the TUE 1 perform user equipment cooperation on an unlicensed frequency band. Whether the CUE 1 (or the CUE 2) and the TUE 1 perform in-band or out-of-band user equipment cooperation may be notified by the access network device. A message indicating whether the CUE 1 (or the CUE 2) and the TUE 1 perform in-band or out-of-band user equipment cooperation requires an indication including at least 1-bit information (to be specific, “0” and “1” respectively represent two different cases, for example, a bit 0 represents that the CUE 1 (or the CUE 2) and the TUE 1 perform in-band user equipment cooperation, and a bit 1 represents that the CUE 1 (or the CUE 2) and the TUE 1 perform out-of-band user equipment cooperation). The indication may be carried in downlink control information of the access network device, or system information (for example, System Information Block, SIB), or other upper-layer signaling (for example, radio resource control (RRC) signaling).

In the embodiments of the present invention, in some cases, the UE may be a mobile device, for example, a mobile phone, a personal digital assistant (PDA), a handheld or laptop computer, and a similar device with a telecommunication capability. The UE may include a device and an associated removable storage module (for example, including but not limited to: a subscriber identity module (SIM) application, a universal subscriber identity module (USIM) application, or a universal integrated circuit card (UICC) of a removable user identify module (R-UIM) application). In one embodiment, the UE may include a device that does not include the module. In another case, the UE may be a non-portable device having a similar capability, for example, a desktop computer, a set top box, or a network device. The UE may alternatively be any hardware or software component that is used by a user to initiate a communication session. In addition, the user equipment described in the embodiments of the present invention may also be referred to as an access terminal, a terminal device, a subscriber unit, a subscriber station, a mobile station, a mobile console, a remote station, a remote terminal, a mobile device, a user terminal, a terminal, a wireless communications device, a user agent, or a user apparatus.

In the embodiments of the present invention, the access network device may include a system and a device improved from an equivalent device in a conventional wireless telecommunications system. The advanced or next-generation device may be included in an evolved wireless communications standard (for example, Long Term Evolution (LTE)). For example, an LTE system may include a NodeB (evolved NodeB, eNB), a wireless access point, or a similar component in an evolved universal terrestrial radio access network (E-UTRAN), instead of a conventional base station. Any such component is referred to as an eNB in this specification. However, it should be understood that such component may not necessarily be an eNB. In a next generation communications system, the eNB in the LTE system is replaced by a gNB. In addition, the access network device may also be referred to as a base station.

In the embodiments of the present invention, sidelink communication may also be referred to as “device-to-device (D2D)” communication, “a proximity service (ProSe)”, “direct communication between devices”, or the like.

FIG. 2 shows an example of the communications system 200 that includes one access network device, two CUEs, and one TUE. It should be noted that the communications system 200 may include more than one access network device, may include more than two CUEs, and may include more than one TUE. This is not limited in the embodiments of the present invention.

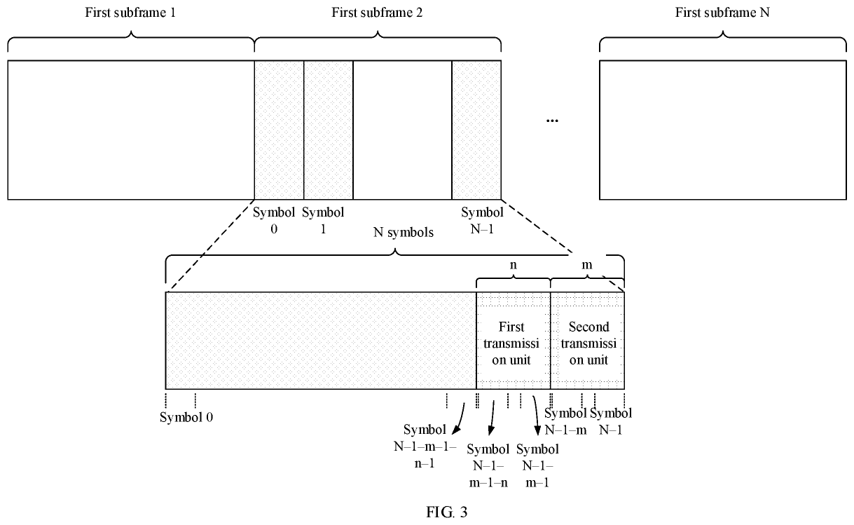

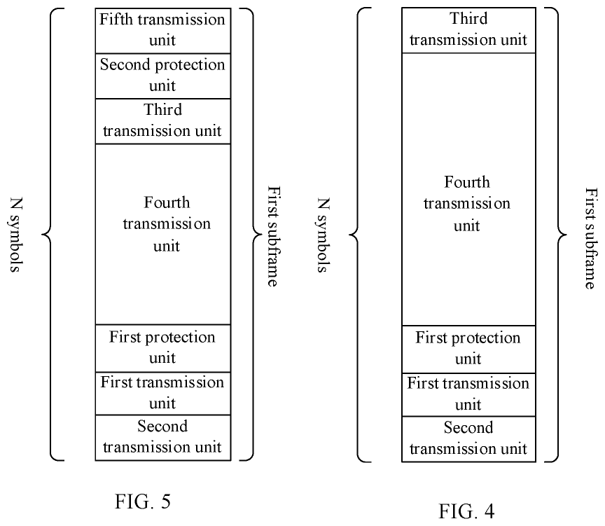

Three types of structures of first subframes provided in the embodiments of the present invention are first described with reference to FIG. 4 to FIG. 6. In a wireless communications system, a concept of a radio frame is defined in time domain. Each radio frame includes several subframes, and one subframe includes several symbols. The following operations may be completed in a same subframe: A gNB sends downlink control information (optional) to CUE and TUE; sidelink information (including at least one of control information and data information) is sent or received during sidelink communication between the CUE and the TUE; and the TUE sends uplink feedback information (also belonging to control information) to the gNB. The subframe is also referred to as a self-contained subframe. The subframe is defined as a first subframe in the embodiments of the present invention, and may be named as a cooperative subframe or may have another name. FIG. 3 is a schematic structural diagram of a first subframe according to an embodiment of the present invention. In this embodiment of the present invention, the first subframe includes N symbols (a first symbol is numbered 0, and a last symbol is numbered N−1). Last m(m≥1, m∈Z) symbols in the first subframe, namely, symbols {N−1−m, Λ, N−1} form a second transmission unit. The second transmission unit is used by the TUE to perform uplink transmission. The uplink feedback information sent by the TUE to the gNB is carried in the second transmission unit. Before the second transmission unit, there are n(n≥1, n∈Z) symbols, namely, symbols {N−1−m−1−n, Λ, N−1−m−1}. The n symbols form a first transmission unit. The first transmission unit is used by the TUE to perform sidelink transmission. Sidelink feedback information sent by the TUE to the CUE is carried in the first transmission unit. Symbols {0, Λ, N−1−m−1−n−1} are used by the gNB, the CUE, or the TUE to send or receive other information (specific included information depends on different user equipment cooperation modes and categories). For example, the first transmission unit may be named as a sidelink reverse control (SL Reverse Control) information unit, and the second transmission unit may be named as an uplink control (UL Control) information unit. In the foregoing mathematical expressions, (m+n)<N.

The symbols {0, Λ, N−1−m−1−n−1} in FIG. 3 may be used for different purposes based on different user equipment cooperation types. In one embodiment, user equipment cooperation may have two modes: Mode 1 is defined as a user equipment autonomous mode (UE Autonomous), and Mode 2 is defined as a user equipment scheduling mode (UE Scheduled Mode). In Mode 2, there are two categories: Category 1 is defined as a user equipment independent category, and Category 2 is defined as a user equipment unified category.

For the user equipment autonomous mode, downlink control information is not required in each first subframe, and the downlink control information is transmitted to the TUE and the CUE by using a second subframe. Herein, the second subframe is a type of subframe different from the first subframe. For a structure of the second subframe, refer to a subframe structure in an existing LTE system. For example, the second subframe includes at least a downlink control information transmission unit and a downlink data transmission unit. The second subframe may be named as a non-cooperative subframe or may have another name. For the user equipment scheduling mode, downlink control information is required in each first subframe, and the downlink control information is used to schedule and instruct the CUE and the TUE to perform sending and receiving during sidelink communication. For the user equipment independent category, sidelink data (SL Data) sent by the CUE necessarily includes sidelink control (SL Control) information, and the sidelink control information is used to instruct the TUE to receive the sidelink data. For the user equipment unified category, the sidelink data sent by the CUE does not necessarily correspond to the sidelink control information.

In one embodiment, FIG. 4 is a schematic structural diagram of another first subframe according to an embodiment of the present invention. The first subframe may be used by the CUE and the TUE to perform user equipment cooperation when the user equipment cooperation mode is the user equipment autonomous mode. As shown in FIG. 4, the first subframe includes a first transmission unit and a second transmission unit. In addition, the first subframe further includes a third transmission unit, a fourth transmission unit, and a first protection unit. The third transmission unit is adjacent to the fourth transmission unit, the third transmission unit is prior to the fourth transmission unit, and the fourth transmission unit is prior to the first transmission unit. The third transmission unit is used by the CUE to send, to the TUE, sidelink control information corresponding to sidelink data. The fourth transmission unit is used by the CUE to send the sidelink data to the TUE. The first protection unit in FIG. 4 represents a protection symbol (including a size of at least one symbol), and is used by the TUE to provide protection for sending and receiving processing. It should be noted that, when the TUE receives the sidelink data, the TUE needs a period of time to perform a series of receiving processing on the sidelink data and prepare data that needs to be sent. Therefore, a period of time, namely, the first protection unit is reserved in the subframe. For example, the third transmission unit may be named as a sidelink control (SL Control) unit, and the fourth transmission unit may be named as a sidelink data (SL Data) unit.

FIG. 5 is a schematic structural diagram of another first subframe according to an embodiment of the present invention. The first subframe may be used by the CUE and the TUE to perform user equipment cooperation when the user equipment cooperation mode is the user equipment scheduling mode and the user equipment cooperation category is the user equipment independent category. As shown in FIG. 5, the first subframe includes a first transmission unit and a second transmission unit. In addition, the first subframe further includes a third transmission unit, a fourth transmission unit, a fifth transmission unit, a first protection unit, and a second protection unit. The third transmission unit is used by the CUE to send, to the TUE, sidelink control information corresponding to sidelink data. The fourth transmission unit is used by the CUE to send the sidelink data to the TUE. The fifth transmission unit is used by the gNB to send downlink control information to the CUE and the TUE. The first protection unit in FIG. 5 represents a protection symbol (including a size of at least one symbol), and is mainly used by the TUE to provide protection for sending and receiving processing. The second protection unit in FIG. 5 also represents a protection symbol (including a size of at least one symbol), and is used by the CUE to provide protection for sending and receiving processing. For example, the fifth transmission unit may be named as a downlink control (DL Control) information unit.

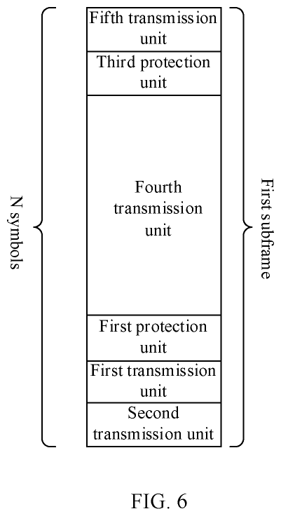

FIG. 6 is a schematic structural diagram of another first subframe according to an embodiment of the present invention. The first subframe may be used by the CUE and the TUE to perform user equipment cooperation when the user equipment cooperation mode is the user equipment scheduling mode and the user equipment cooperation category is the user equipment unified category. As shown in FIG. 6, the first subframe includes a first transmission unit and a second transmission unit. In addition, the first subframe further includes a fourth transmission unit, a first protection unit, and a third protection unit. The fourth transmission unit is used by the CUE to send sidelink data to the TUE. The first protection unit in FIG. 6 represents a protection symbol (including a size of at least one symbol), and is mainly used by the TUE to provide protection for sending and receiving processing. The third protection unit in FIG. 6 also represents a protection symbol (including a size of at least one symbol), and is used by the CUE to provide protection for sending and receiving processing.

It should be noted that, although the first subframe structures shown in FIG. 3 to FIG. 6 separately correspond to two user equipment cooperation modes and user equipment cooperation categories, a structure of the first subframe does not necessarily correspond to a user equipment cooperation mode and (or) category.

It should be noted that, cooperative control information described in the embodiments of the present invention is downlink control information sent by the access network device, and may be L1 layer signaling or L2 layer signaling. The cooperative control information may indicate a user equipment cooperation mode and/or category. For example, 2 bits may be used to indicate the two user equipment cooperation modes and the two user equipment cooperation categories described in the embodiments of the present invention. For example, when the bits are 00, it indicates that the user equipment cooperation mode is the user equipment autonomous mode. When the bits are 01, it indicates that the user equipment cooperation mode is the user equipment scheduling mode, and that the user equipment cooperation category is the user equipment independent category. When the bits are 10, it indicates that the user equipment cooperation mode is the user equipment scheduling mode, and that the user equipment cooperation category is the user equipment unified category. Alternatively, two formats of cooperative control information are defined to respectively indicate the two user equipment cooperation modes. For example, a cooperative control information format X is defined to indicate that the user equipment cooperation mode is the user equipment autonomous mode, and a cooperative control information format Y is defined to indicate that the user equipment cooperation mode is the user equipment scheduling mode. When the user equipment cooperation category is the user equipment independent category, the cooperative control information format Y is bound to IDs of different users. To be specific, CUE 1 may obtain, after decoding by using an ID of the CUE 1, the cooperative control information format Y configured by the gNB for the CUE 1; CUE 2 may obtain, after decoding by using an ID of the CUE 2, the cooperative control information format Y configured by the gNB for the CUE 2; and TUE 1 may obtain, after decoding by using an ID of the TUE 1, the cooperative control information format Y configured by the gNB for the TUE 1. When the user equipment cooperation category is the user equipment unified category, the cooperative control information format Y is bound to a cooperation group ID. To be specific, the CUE 1, the CUE 2, and the TUE 1 may obtain, after decoding by using the cooperation group ID, the cooperative control information format Y configured by the gNB for a cooperation group. The CUE determines, based on the cooperative control information format, to use which user equipment cooperation mode and/or user equipment cooperation category. In the user equipment autonomous mode, the CUE may autonomously select a physical transmission resource used during transmission of sidelink data and control information of the sidelink data. For example, an independent physical transmission resource block is allocated to the CUE before delivery. When performing sidelink communication with the TUE, the CUE may autonomously select at least a part of physical transmission resource from the pre-allocated physical transmission resource to perform sidelink transmission. Alternatively, the cooperative control information may carry information about a physical transmission resource allocated by the gNB to the CUE. When performing sidelink communication with the TUE, the CUE may autonomously select at least a part of physical transmission resource from the physical transmission resource allocated by the gNB to the CUE, to perform sidelink transmission. In the user equipment scheduling mode and in the user equipment independent category, a physical transmission resource used for sidelink transmission between the CUE and the TUE is allocated by the gNB and carried in the cooperative control information, and the gNB may allocate different physical transmission resources for different CUEs. In the user equipment scheduling mode and in the user equipment unified category, a physical transmission resource used for sidelink transmission between the CUE and the TUE is allocated by the gNB and carried in the cooperative control information, and the gNB allocates a same physical transmission resource for different CUEs.

The present invention provides a specific method for implementing user equipment cooperation between first user equipment and second user equipment under control of an access network device. In different user equipment cooperation modes and categories, a corresponding first subframe format is designed. The first user equipment and the second user equipment may use the first subframe under control of the access network device, and complete a user equipment cooperation process with optimal resource configuration. According to the implementation method in the present invention, the user equipment cooperation can meet requirements in different scenarios more robustly in a condition of a relatively low latency, thereby improving quality of service and optimizing system performance.

The following describes a user equipment cooperation process in different user equipment cooperation modes and/or user equipment cooperation categories according to an embodiment of the present invention.

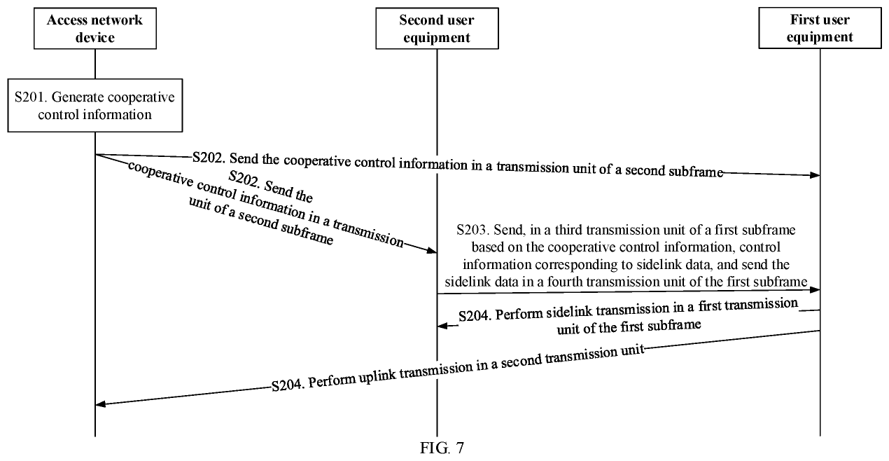

Based on the schematic architectural diagram of the system shown in FIG. 2, FIG. 7 is a flowchart of a user equipment cooperation method according to an embodiment of the present invention. In this embodiment of the present invention, a user equipment cooperation mode is a user equipment autonomous mode. The cooperation method includes the following operations.

Operation S201. An access network device generates cooperative control information, where the cooperative control information is used to instruct first user equipment to perform sidelink transmission in a first transmission unit of a first subframe and perform uplink transmission in a second transmission unit of the first subframe, and the cooperative control information is further used to instruct second user equipment to send, to the first user equipment in a third transmission unit of the first subframe, control information corresponding to sidelink data, and send the sidelink data to the first user equipment in a fourth transmission unit of the first subframe.

In this embodiment of the present invention, the sidelink transmission includes that the first user equipment sends feedback information to the second user equipment. The first user equipment is TUE, and the second user equipment is CUE. There are one or more second user equipments. There are one or more first subframes. The first subframe is the first subframe shown in FIG. 4.

In this embodiment of the present invention, the cooperative control information includes one or more types of the following information: 1. downlink scheduling information used by the CUE and the TUE to receive downlink data sent by the access network device; 2. sidelink scheduling information used by the CUE and the TUE to perform user equipment cooperation, including: a physical transmission resource used by the CUE to send the control information of the sidelink data to the TUE, a physical transmission resource used by the CUE to send the sidelink data to the TUE, a physical transmission resource used by the TUE to send sidelink reverse control information to the CUE, and a physical transmission resource used by the TUE to send uplink control information to a gNB; 3. a sending parameter (for example, a modulation and coding scheme (MCS) or antenna configuration) used by the CUE to send the sidelink control information to the TUE and used by the TUE to send the sidelink reverse control information to the CUE; 4. uplink scheduling information used by the TUE to send uplink feedback information to the access network device; and 5. a forwarding scheme used to instruct the CUE to send the sidelink data to the TUE, where the forwarding scheme includes but is not limited to: an amplify-and-forward (AF) scheme, a decode-and-forward (DF) scheme, a compress-and-forward (CF) scheme, and a soft-forwarding (SF) scheme.

Operation S202. The access network device sends the cooperative control information to the first user equipment and the second user equipment in a transmission unit of a second subframe.

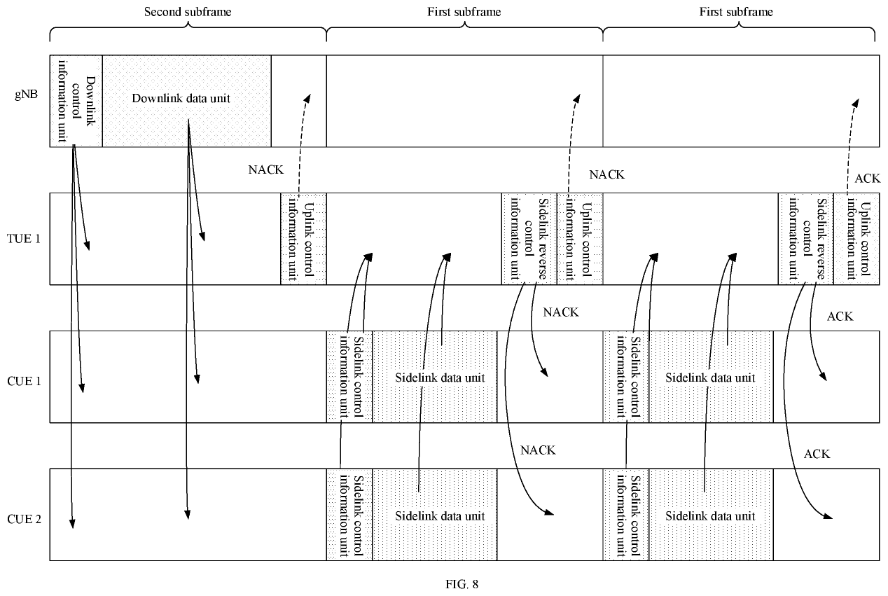

In one embodiment, this operation is described with reference to a time-domain diagram of a user equipment cooperation process shown in FIG. 8. A gNB sends, to TUE 1, CUE 1, and CUE 2 in a multicast manner, downlink control information in a downlink control information transmission unit of the second subframe and downlink data in a downlink data unit of the second subframe by using a cooperation group ID. The gNB adds the cooperative control information to the downlink control information.

Operation S203. The second user equipment receives the cooperative control information sent by the access network device; sends, to the first user equipment in the third transmission unit of the first subframe based on the cooperative control information, the control information corresponding to the sidelink data; and sends the sidelink data to the first user equipment in the fourth transmission unit of the first subframe.

In one embodiment, the second user equipment may successfully decode the received downlink control information by using the cooperation group ID, obtain the cooperative control information from the downlink control information, and determine, based on the cooperative control information, that the user equipment cooperation mode is the user equipment autonomous mode. If a physical transmission resource required in the sidelink transmission is preconfigured before delivery, the second user equipment selects a part of physical transmission resource from the preconfigured physical transmission resource to transmit the sidelink data and the control information of the sidelink data; or if a physical transmission resource required in the sidelink transmission is indicated in the cooperative control information, the second user equipment selects a part of physical transmission resource from the physical transmission resource indicated in the cooperative control information to transmit the sidelink data and the control information of the sidelink data. The selected physical transmission resource used to transmit the control information of the sidelink data is the third transmission unit shown in FIG. 4, and the selected physical transmission resource used to transmit the sidelink data is the fourth transmission unit shown in FIG. 4. Further, the second user equipment sends the control information of the sidelink data to the first user equipment by using the third transmission unit, and sends the sidelink data to the first user equipment by using the fourth transmission unit. The control information includes sidelink scheduling information used to instruct the first user equipment to receive the sidelink data, and the control information may further include indication information used to indicate a physical transmission resource used when the TUE feeds back sidelink information to the CUE and indication information used to indicate the physical transmission resource used when the TUE feeds back the uplink control information to the gNB.

A sending parameter (for example, an MCS or antenna configuration) used when the second user equipment sends the sidelink data and the control information of the sidelink data to the first user equipment may be the sending parameter indicated in the cooperative control information. A forwarding scheme (for example, an FS scheme, an AF scheme, a DF scheme, a CF scheme, or an SF scheme) used when the second user equipment sends the sidelink data and the control information of the sidelink data to the first user equipment may also be the forwarding scheme indicated in the cooperative control information.

In one embodiment, referring to FIG. 8, the CUE 1 and the CUE 2 randomly select at least a part of physical transmission resource from the physical transmission resource that is indicated in the cooperative control information and that is used by the cooperation group to perform the user equipment cooperation, to send the sidelink control information and the sidelink data. The CUE 1 and the CUE 2 select a forwarding scheme based on an indication of the cooperative control information. The TUE 1 selects, based on the indication of the cooperative control information, a forwarding scheme to receive the sidelink control information and the sidelink data. In one embodiment, the CUE 1 is used as an example. The CUE 1 selects, based on a channel condition of the CUE 1 and the TUE 1, a sending parameter (for example, an MCS or antenna configuration) of sending the sidelink data, adds the sending parameter into the sidelink control information, and randomly selects at least a part of physical resource from a physical resource for user equipment cooperation based on an indication of the cooperative control information, to send the sidelink control information and the sidelink data to the TUE 1. An operation performed by the CUE 2 is similar to that performed by the CUE 1.

The first user equipment receives the cooperative control information sent by the access network device, receives, in the third transmission unit based on the cooperative control information, the control information that is of the sidelink data and that is sent by the second user equipment, and receives, in the fourth transmission unit based on the control information, the sidelink data sent by the second user equipment.

In one embodiment, the first user equipment may successfully decode, by using the cooperation group ID, the received downlink control information sent by the access network device, and obtain the cooperative control information from the downlink control information. Because the first user equipment fails to correctly decode the downlink data sent by the access network device, the first user equipment feeds back uplink control information (for example, a NACK) to the gNB in an uplink control information unit of the second subframe based on the cooperative control information, or does not send any feedback information in an uplink control information unit of the second subframe. In addition, the first user equipment determines, based on the cooperative control information, that the user equipment cooperation mode is the user equipment autonomous mode. If the physical transmission resource required in the sidelink transmission is preconfigured before delivery, the first user equipment receives, on the preconfigured physical transmission resource, the control information that is of the sidelink data and that is sent by the second user equipment. Herein, the preconfigured physical transmission resource is greater than or equal to the third transmission unit. Therefore, the first user equipment may receive the control information, and further receive the sidelink data in the fourth transmission unit based on the control information. If the physical transmission resource required in the sidelink transmission is indicated in the cooperative control information, the first user equipment receives, on the physical transmission resource indicated in the cooperative control information, the control information that is of the sidelink data and that is sent by the second user equipment. Herein, the physical transmission resource indicated in the cooperative control information is greater than or equal to the third transmission unit. Therefore, the first user equipment may receive the control information, and further receive the sidelink data in the fourth transmission unit based on the control information. The control information includes the sidelink scheduling information used to instruct the first user equipment to receive the sidelink data.

In one embodiment, referring to FIG. 8, the TUE 1 receives, based on the sidelink control information sent by the CUE 1 in a sidelink control information unit (corresponding to a first sidelink control information unit in FIG. 8), the sidelink data sent by the CUE 1 in a sidelink data unit (corresponding to a first sidelink data unit in FIG. 8); and receives, based on the sidelink control information sent by the CUE 2 in a sidelink control information unit (corresponding to a first sidelink control information unit in FIG. 8), the sidelink data sent by the CUE 2 in a sidelink data unit (corresponding to a first sidelink data unit in FIG. 8).

Operation S204. The first user equipment performs, based on the cooperative control information, the sidelink transmission in the first transmission unit of the first subframe and the uplink transmission in the second transmission unit of the first subframe.

Referring to FIG. 8, if the TUE 1 cannot correctly decode the sidelink data from the CUE 1 and the sidelink data from the CUE 2, the TUE 1 feeds back, in a sidelink reverse control information unit (corresponding to a first sidelink reverse control information unit in FIG. 8) based on an indication of the sidelink control information sent by the CUE 1, a NACK to the CUE 1 by using the sending parameter indicated in the cooperative control information; and feeds back, in a sidelink reverse control information unit (corresponding to a first sidelink reverse control information unit in FIG. 8) based on an indication of the sidelink control information sent by the CUE 2, a NACK to the CUE 2 by using the sending parameter indicated in the cooperative control information. The TUE 1 feeds back uplink control information (for example, a NACK) to the gNB in an uplink control information unit (corresponding to second uplink control information unit in FIG. 8) of the first subframe based on an indication of the cooperative control information, or does not send any feedback information in an uplink control information unit of the first subframe. The user equipment cooperation is continuously performed in a next first subframe (which needs to be within the physical resource configured by the gNB for the user equipment cooperation). In other words, operations S203 to S205 are repeated.

If the TUE 1 correctly decodes the sidelink data from the CUE 1 and the sidelink data from the CUE 2, the TUE 1 feeds back, in a sidelink reverse control information unit (corresponding to a first sidelink reverse control information unit in FIG. 8) based on each of an indication of the sidelink control information sent by the CUE 1 and an indication of the sidelink control information sent by the CUE 2, an ACK to each of the CUE 1 and the CUE 2 by using a sending parameter indicated in the cooperative control information; and the TUE 1 feeds back uplink control information (for example, an ACK) to the gNB in an uplink control information unit (for example, corresponding to a third uplink control information unit in FIG. 8) of the first subframe based on an indication of the cooperative control information. The user equipment cooperation process ends. It should be noted that, the CUE 1 and the CUE 2 may feed back the uplink control information (for example, an ACK) to the gNB in an uplink control information unit (corresponding to third uplink control information unit in FIG. 8) of the first subframe after the ACK sent by the TUE 1 is received.

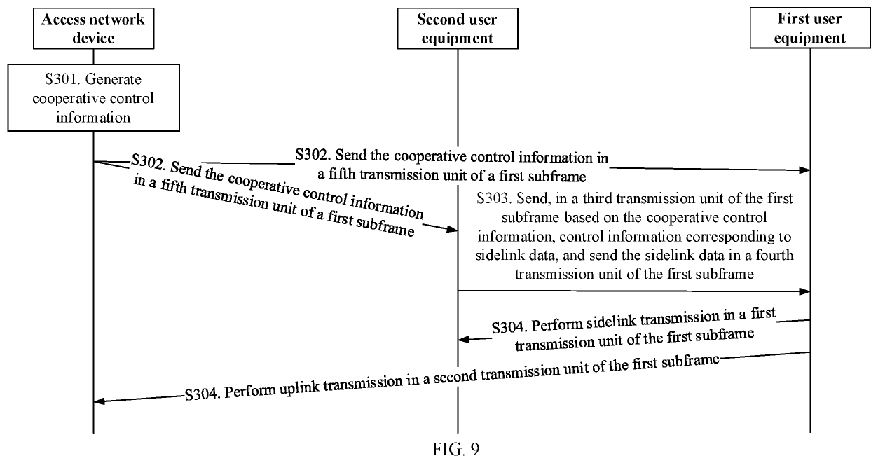

Based on the schematic architectural diagram of the system shown in FIG. 2, FIG. 9 is a flowchart of another user equipment cooperation method according to an embodiment of the present invention. In this embodiment of the present invention, a user equipment cooperation mode is a user equipment scheduling mode, and a user equipment cooperation category is a user equipment independent category. The cooperation method includes the following operations.

Operation S301. An access network device generates cooperative control information, where the cooperative control information is used to instruct first user equipment to perform sidelink transmission in a first transmission unit of a first subframe and perform uplink transmission in a second transmission unit of the first subframe, and the cooperative control information is further used to instruct second user equipment to send, to the first user equipment in a third transmission unit of the first subframe, control information corresponding to sidelink data, and send the sidelink data to the first user equipment in a fourth transmission unit of the first subframe.

In this embodiment of the present invention, the sidelink transmission includes that the first user equipment sends feedback information to the second user equipment. The first user equipment is TUE, and the second user equipment is CUE. There may be one or more second user equipments. There may be one or more first subframes, and the first subframe is the first subframe shown in FIG. 5.

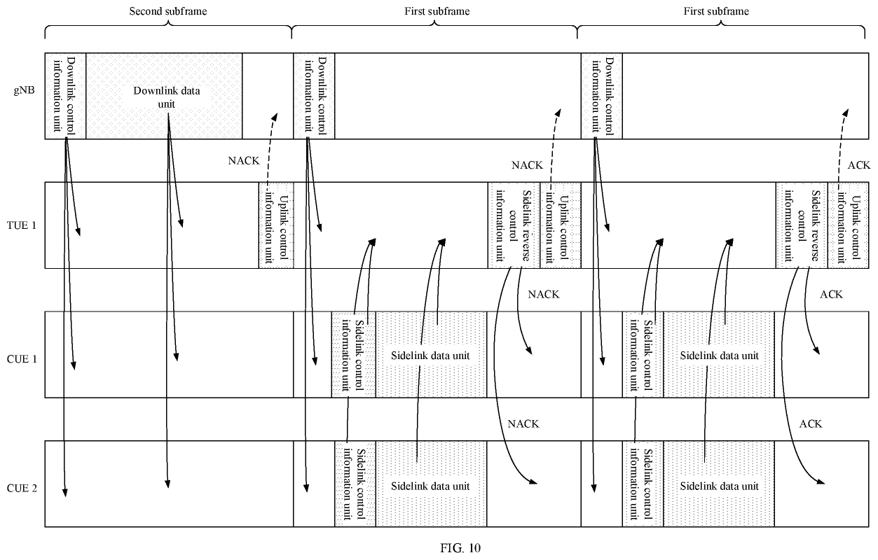

This operation is described with reference to a time-domain diagram of a user equipment cooperation process shown in FIG. 10. Before sending the cooperative control information, a gNB sends downlink control information (corresponding to first downlink control information unit in FIG. 10) and downlink data to TUE 1, CUE 1, and CUE 2 in a transmission unit of a second subframe in a multicast manner by using a cooperation group ID. Herein, the downlink control information is further used to instruct the CUE 1, the CUE 2, and the TUE 1 to perform user equipment cooperation. The CUE 1, the CUE 2, and TUE 1 successfully decode the downlink control information (corresponding to the first downlink control information unit in FIG. 10) by using the cooperation group ID. The CUE 1, the CUE 2, and the TUE 1 receive the downlink data based on the downlink control information. In addition, the CUE 1, the CUE 2, and the TUE 1 determine, based on the downlink control information, that the user equipment cooperation needs to be performed. Because the TUE 1 fails to correctly decode the downlink data, the TUE 1 feeds back uplink control information (for example, a NACK) (corresponding to first uplink control information unit in FIG. 10) to the gNB on an uplink control channel of the second subframe based on an indication of the downlink control information (corresponding to the first downlink control information unit in FIG. 10), or does not send any feedback information on an uplink control channel of the second subframe.

In this embodiment of the present invention, the cooperative control information includes: 1. sidelink scheduling information used by the CUE to perform the user equipment cooperation, to be specific, a physical resource used by the CUE to perform the user equipment cooperation (including the sidelink control information (corresponding to the third transmission unit in FIG. 5) and the sidelink data (corresponding to the fourth transmission unit in FIG. 5), sidelink reverse control information (corresponding to the first transmission unit in FIG. 5) fed back by the TUE 1 to the CUE, and uplink control information (corresponding to the second transmission unit in FIG. 5) fed back by the TUE 1 to the gNB). In addition, the cooperative control information may further include one or more types of the following information: 2. a forwarding scheme used to instruct the CUE to send the sidelink data to the TUE 1, where the forwarding scheme includes but is not limited to: an AF scheme, a DF scheme, a CF scheme, and an SF scheme; and 3. a sending parameter (for example, an MCS or antenna configuration) used by the CUE and the TUE 1 to respectively send the sidelink control information and the sidelink reverse control information. It should be noted that, the sending parameter (for example, an MCS or antenna configuration) used by the CUE and the TUE 1 to respectively send the sidelink control information and the sidelink reverse control information may be predefined, or may be obtained by using system information (SIB) of the gNB.

Operation S302. The access network device sends the cooperative control information to the first user equipment and the second user equipment in a fifth transmission unit of the first subframe.

In one embodiment, the gNB sends the cooperative control information in the fifth transmission unit (corresponding to a second downlink control information unit in FIG. 10) of the first subframe, and adds the cooperative control information into the fifth transmission unit.

Operation S303. The second user equipment receives the cooperative control information sent by the access network device, sends, to the first user equipment in the third transmission unit based on the cooperative control information, control information corresponding to the sidelink data, and sends the sidelink data to the first user equipment in the fourth transmission unit.

In one embodiment, the second user equipment determines, based on the cooperative control information, that the user equipment cooperation mode is the user equipment scheduling mode, and that the user equipment cooperation category is the user equipment independent category. Further, based on a physical transmission resource indicated in the cooperative control information, the second user equipment sends the control information of the sidelink data to the first user equipment in the third transmission unit, and sends the sidelink data to the first user equipment in the fourth transmission unit. Herein, the physical transmission resource used to transmit the control information and the physical transmission resource used to transmit the sidelink data are both indicated in the cooperative control information. The control information includes sidelink scheduling information used to instruct the first user equipment to receive the sidelink data.

If the cooperative control information uses 2 bits to indicate the user equipment cooperation mode and the user equipment cooperation category, the second user equipment directly parses the 2 bits to determine that the user equipment cooperation mode is the user equipment scheduling mode, and that the user equipment cooperation category is the user equipment independent category. If the cooperative control information is identified by using a format of the cooperative control information, the second user equipment determines, based on the format of the cooperative control information, that the format of the cooperative control information is a cooperative control information format Y; and the second user equipment may further decode, by using an ID of the second user equipment, the cooperative control information configured by the gNB, and may determine that the user equipment cooperation mode is the user equipment scheduling mode, and that the user equipment cooperation category is the user equipment independent category.

The CUE 1 is used as an example. The CUE 1 determines that the user equipment cooperation category is the user equipment independent category, and then sends the sidelink control information and the sidelink data on user equipment cooperation physical resources specified in the cooperative control information. The CUE 1 selects a forwarding scheme based on an indication of the cooperative control information. The TUE 1 selects, based on the indication of the cooperative control information, a forwarding scheme to process the sidelink data. An operation performed by the CUE 2 is similar to that performed by the CUE 1.

The first user equipment receives the cooperative control information sent by the access network device, receives, in the third transmission unit based on the cooperative control information, the control information that is of the sidelink data and that is sent by the second user equipment, and receives, in the fourth transmission unit based on the control information, the sidelink data sent by the second user equipment.

In one embodiment, the first user equipment obtains the cooperative control information, and determines, based on the cooperative control information, that the user equipment cooperation mode is the user equipment scheduling mode, and that the user equipment cooperation category is the user equipment independent category. In this case, a physical transmission resource required in the sidelink transmission is indicated in the cooperative control information, and the first user equipment receives, on the physical transmission resource indicated in the cooperative control information, the control information that is of the sidelink data and that is sent by the second user equipment. Herein, the physical transmission resource indicated in the cooperative control information is equal to the third transmission unit. Therefore, the first user equipment may receive the control information, and further receive the sidelink data in the fourth transmission unit based on the control information. The control information includes sidelink scheduling information used to instruct the first user equipment to receive the sidelink data.

In one embodiment, referring to FIG. 10, the TUE 1 respectively receives the sidelink data from the CUE 1 and the sidelink data from the CUE 2 based on an indication of the sidelink control information from the CUE 1 and an indication of the sidelink control information from the CUE 2.

Operation S304. The first user equipment performs, based on the cooperative control information, the sidelink transmission in the first transmission unit and the uplink transmission in the second transmission unit.

Referring to FIG. 10, if the TUE 1 cannot correctly decode the sidelink data from the CUE 1 and the sidelink data from the CUE 2, the TUE 1 feeds back, in a sidelink reverse control information unit based on an indication of the sidelink control information sent by the CUE 1 and an indication of the sidelink control information sent by the CUE 2, a NACK by using a sending parameter indicated in the cooperative control information; the TUE 1 feeds back uplink control information (for example, a NACK) to the gNB in an uplink control information unit (corresponding to a second uplink control information unit in FIG. 10) of the second subframe based on an indication of the cooperative control information, or does not send any feedback information in an uplink control information unit (corresponding to a second uplink control information unit in FIG. 10) of the second subframe. The user equipment cooperation is continuously performed in a next first subframe (which needs to be within a physical resource configured by the gNB for the user equipment cooperation). In other words, operations S303 to S305 are repeated.

If the TUE 1 correctly decodes the sidelink data from the CUE 1 or the sidelink data from the CUE 2, the TUE 1 separately feeds back, in a sidelink reverse control information unit (corresponding to a second sidelink reverse control information unit in FIG. 10) based on an indication of the sidelink control information sent by the CUE 1 and an indication of the sidelink control information sent by the CUE 2, an ACK by using a sending parameter indicated in the cooperative control information; the TUE 1 feeds back uplink control information (for example, an ACK) to the gNB in an uplink control information unit (corresponding to a third uplink control information unit in FIG. 10) of the second subframe based on an indication of the cooperative control information. The user equipment cooperation process ends. It should be noted that, the CUE 1 and the CUE 2 may feed back uplink control information (for example, an ACK) (corresponding to third uplink control information unit in FIG. 10) to the gNB in an uplink control information unit of the first subframe after receiving the ACK sent by the TUE 1.

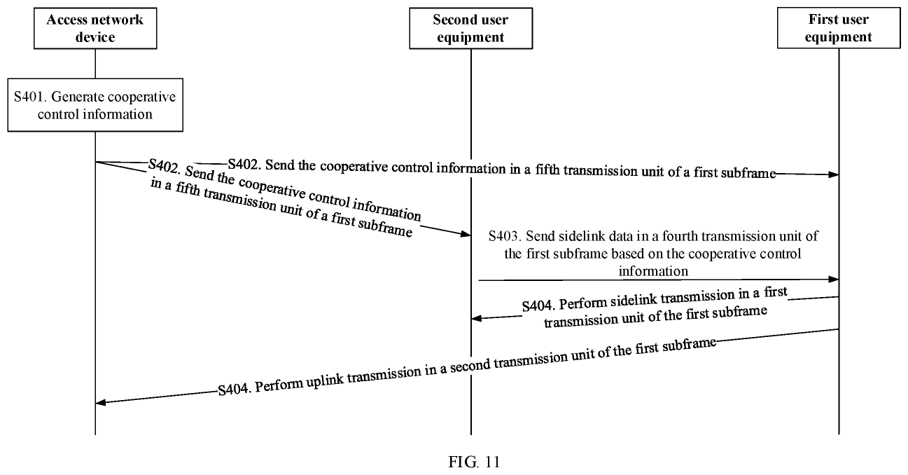

Based on the schematic architectural diagram of the system shown in FIG. 2, FIG. 11 is a flowchart of another user equipment cooperation method according to an embodiment of the present invention. In this embodiment of the present invention, a user equipment cooperation mode is a user equipment scheduling mode, and a user equipment cooperation category is a user equipment unified category. The cooperation method includes the following operations.

Operation S401. An access network device generates cooperative control information, where the cooperative control information is used to instruct first user equipment to perform sidelink transmission in a first transmission unit of a first subframe and perform uplink transmission in a second transmission unit of the first subframe, and the cooperative control information is further used to instruct second user equipment to send sidelink data to the first user equipment in a fourth transmission unit of the first subframe.

In this embodiment of the present invention, the sidelink transmission includes that the first user equipment sends feedback information to the second user equipment. The first user equipment is TUE, and the second user equipment is CUE. There may be one or more second user equipments. There may be one or more first subframes, and the first subframe is the first subframe shown in FIG. 6.

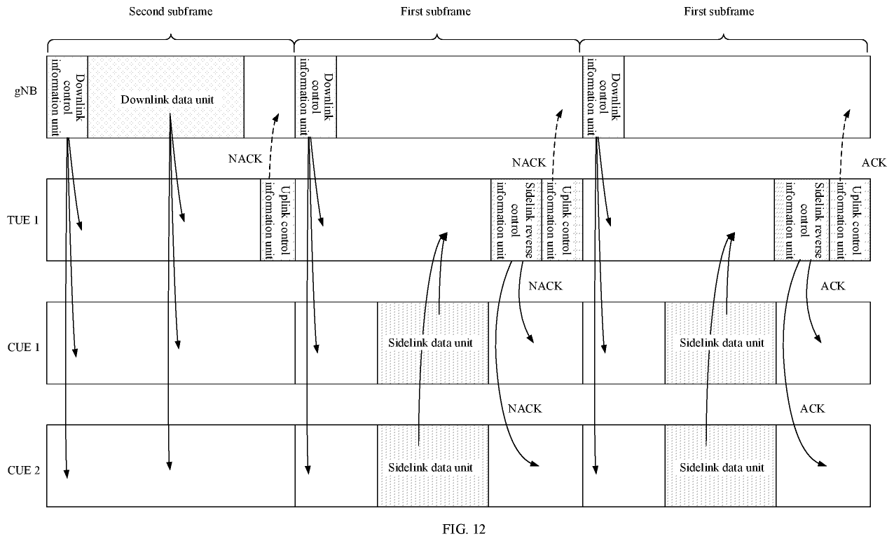

This operation is described with reference to a time-domain diagram of a user equipment cooperation process shown in FIG. 12. Before sending the cooperative control information, a gNB sends downlink control information to the TUE 1, CUE 1, and CUE 2 in a downlink control information unit (corresponding to a first downlink control information unit in FIG. 12) of a second subframe in a multicast manner by using a cooperation group ID, and sends downlink data to the TUE 1, the CUE 1, and the CUE 2 in a downlink data unit of the second subframe in a multicast manner by using the cooperation group ID. The CUE 1, the CUE 2, and the TUE 1 successfully decode the downlink control information by using the cooperation group ID. The CUE 1, the CUE 2, and the TUE 1 receive the downlink data based on the downlink control information. Because the TUE 1 fails to correctly decode the downlink data, the TUE 1 feeds back uplink control information (for example, a NACK) to the gNB on an uplink control channel (corresponding to a first uplink control information unit in FIG. 12) of the second subframe based on an indication of the downlink control information, or does not send any feedback information on the uplink control channel.

In this embodiment of the present invention, the cooperative control information includes: 1. sidelink scheduling information used by the CUE and the TUE 1 to perform user equipment cooperation, to be specific, a physical resource used by the CUE to perform the user equipment cooperation (including: sidelink data (corresponding to the fourth transmission unit in FIG. 6), sidelink reverse control information (corresponding to the first transmission unit in FIG. 6) fed back by the TUE 1 to the CUE, and uplink control information (corresponding to the second transmission unit in FIG. 6) fed back by the TUE 1 to the gNB). The cooperative control information may further include one or more types of the following information: 2. a forwarding scheme used to instruct the CUE to send sidelink data to the TUE 1, where the forwarding scheme includes but is not limited to: an AF scheme, a DF scheme, a CF scheme, and an SF scheme; and 3. a sending parameter (for example, an MCS or antenna configuration) used by the CUE and the TUE 1 to respectively send sidelink control information and sidelink reverse control information. It should be noted that, the sending parameter (for example, an MCS or antenna configuration) used by the CUE and the TUE 1 to respectively send the sidelink control information and the sidelink reverse control information may be predefined, or may be obtained by using system information of the gNB.

Operation S402. The access network device sends the cooperative control information to the first user equipment and the second user equipment in a fifth transmission unit of the first subframe.

In one embodiment, the gNB sends the cooperative control information in the fifth transmission unit (corresponding to a second downlink control information unit in FIG. 12) of the first subframe, and adds the cooperative control information into the fifth transmission unit.

Operation S403. The second user equipment receives the cooperative control information sent by the access network device, and sends the sidelink data to the first user equipment in the fourth transmission unit based on the cooperative control information.

In one embodiment, the CUE 1 and the CUE 2 send the sidelink data on specified user equipment cooperation physical resources based on an indication of the cooperative control information. A physical resource used by the CUE 1 is the same as that used by the CUE 2 (because the cooperative control information is specific to all members in an entire cooperation group), and content of the sidelink data is the same, in other words, CUE 1 SL Data=CUE 2 SL Data.

A sending parameter (for example, an MCS or antenna configuration) used when the second user equipment sends the sidelink data to the first user equipment may be a sending parameter indicated in the cooperative control information. A forwarding scheme (for example, an FS scheme, an AF scheme, a DF scheme, a CF scheme, or an SF scheme) used when the second user equipment sends the sidelink data to the first user equipment may also be a forwarding scheme indicated in the cooperative control information.

Operation S404. The first user equipment receives the cooperative control information sent by the access network device, and receives, in the fourth transmission unit based on the cooperative control information, the sidelink data sent by the second user equipment.

In one embodiment, the first user equipment obtains the cooperative control information, and determines, based on the cooperative control information, that the user equipment cooperation mode is the user equipment scheduling mode, and that the user equipment cooperation category is a user equipment unified category. In this case, a physical transmission resource required in the sidelink transmission is indicated in the cooperative control information, and the first user equipment receives, on the physical transmission resource indicated in the cooperative control information, the sidelink data sent by the second user equipment.

Operation S405. The first user equipment performs, based on the cooperative control information, the sidelink transmission in the first transmission unit and the uplink transmission in the second transmission unit.

Referring to FIG. 12, if the TUE 1 cannot correctly decode the sidelink data from the CUE, the TUE 1 feeds back a NACK to the CUE 1 and the CUE 2 (a physical resource used by the TUE 1 to send the NACK to the CUE 1 is the same as a physical resource used by the TUE 1 to send the NACK to the CUE 2) in a sidelink reverse control information unit (corresponding to a first sidelink reverse control information unit in FIG. 12) based on an indication of the cooperative control information; and the TUE 1 feeds back uplink control information (for example, a NACK) (corresponding to second UL Control unit in FIG. 12) to the gNB in an uplink control information unit (corresponding to second uplink control information unit in FIG. 12) of the second subframe based on an indication of the cooperative control information, or does not send any feedback information in an uplink control information unit (corresponding to second uplink control information unit in FIG. 12) of the second subframe. The user equipment cooperation is continuously performed in a next first subframe (which needs to be within a physical resource configured by the gNB for the user equipment cooperation). In other words, operations S403 to S405 are repeated.

If the TUE 1 correctly decodes the sidelink data from the CUE 1 or the sidelink data from the CUE 2, the TUE 1 feeds back an ACK to the CUE 1 and the CUE 2 (a physical resource used by the TUE 1 to send the ACK to the CUE 1 is the same as that used by the TUE 1 to send the ACK to the CUE 2) in a sidelink reverse control information unit (corresponding to a second sidelink reverse control information unit in FIG. 12) based on an indication of the cooperative control information; and the TUE 1 feeds back uplink control information (for example, an ACK) to the gNB in an uplink control information unit (corresponding to third uplink control information unit in FIG. 12) of the second subframe based on an indication of the cooperative control information. The user equipment cooperation process ends. It should be noted that, the CUE 1 and the CUE 2 may feed back uplink control information (for example, an ACK) (corresponding to third uplink control information unit in FIG. 12) to the gNB in an uplink control information unit of the first subframe after receiving the ACK sent by the TUE 1.

It should be noted that, in the foregoing embodiments of the present invention, the access network device indicates the user equipment cooperation mode and/or the user equipment cooperation category by using the cooperative control information. In actual application, only one user equipment cooperation mode and only one user equipment cooperation category may be defined. For example, a user equipment autonomous mode used when the first user equipment and the second user equipment perform user equipment cooperation is specified in a communications standard. In this case, when separately receiving the cooperative control information sent by the access network device, the first user equipment and the second user equipment determine, based on the cooperative control information, that the user equipment cooperation needs to be performed, and the user equipment cooperation may be automatically performed by using the process in the embodiment shown in FIG. 7 instead of using extra bit information or an extra format to indicate, to the first user equipment and the second user equipment, a specific user equipment cooperation mode and/or category used for user equipment cooperation.

The foregoing describes the solutions provided in the embodiments of the present invention mainly from the perspective of interaction between the access network device, the first user equipment, and the second user equipment. It may be understood that, to implement the foregoing functions, a network device (such as the access network device, the first user equipment, or the second user equipment) includes a corresponding hardware structure and/or software module for performing each function. With reference to units and algorithm operations of each example described in the embodiments disclosed in this application, the embodiments of the present invention may be implemented in a form of hardware or a combination of hardware and computer software. Whether a function is implemented by hardware or by driving hardware by computer software depends on a particular application and design constraint condition of the technical solution. A person skilled in the art may use different methods for each particular application to implement the described functions, but it should not be considered that the implementation goes beyond the scope of the technical solutions of the embodiments of the present invention.

In the embodiments of the present invention, functional unit division may be performed on the network device (such as the access network device, the first user equipment, or the second user equipment) based on the foregoing method examples. For example, each functional unit may be obtained through division based on a corresponding function, or two or more functions may be integrated into one processing unit. The integrated unit may be implemented in a form of hardware, or may be implemented in a form of a software functional unit. It should be noted that unit division is an example in the embodiments of the present invention, and is merely a logical function division. In actual implementation, another division manner may be used.

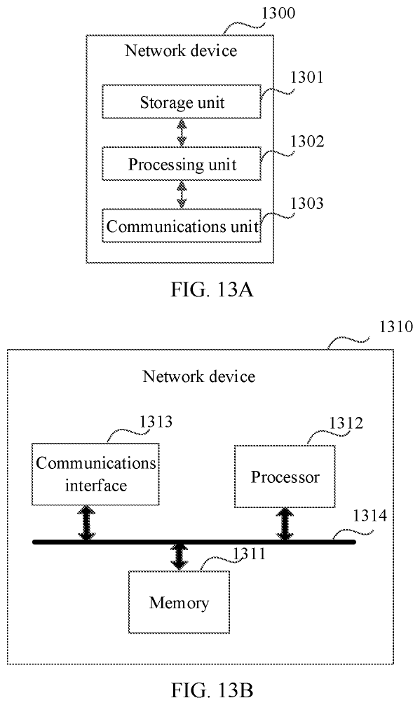

When an integrated unit is used, FIG. 13A is a possible schematic structural diagram of the network device described in the foregoing embodiments. A network device 1300 includes a processing unit 1302 and a communications unit 1303. The processing unit 1302 is configured to control and manage actions of the network device 1300. For example, the processing unit 1302 is configured to support the network device 1300 in performing operation S201 in FIG. 7, operation S301 in FIG. 9, operation S401 in FIG. 11; and/or is configured to perform other operations in the technology described in this specification. The communications unit 1303 is configured to support communication between the network device 1300 and another network device. For example, the communications unit 1303 is configured to support the network device 1300 in performing operation S202, operation S203, and operation S204 in FIG. 7, operation S302, operation S303, and operation S304 in FIG. 9, operation S402, operation S403, and operation S404 in FIG. 11; and/or is configured to perform other operations in the technology described in this specification. The network device 1300 may further include a storage unit 1301, configured to store program code and data of the network device 1300.

The processing unit 1302 may be a processor or a controller, for example, may be a central processing unit (CPU), a general purpose processor, a digital signal processor (DSP), an application-specific integrated circuit (ASIC), a field programmable gate array (FPGA) or another programmable logic device, a transistor logic device, a hardware component, or any combination thereof. The processing unit 1302 may implement or execute various example logical blocks, modules, and circuits described with reference to content disclosed in this application. Alternatively, the processing unit 1302 may be a combination for implementing a computing function, for example, a combination including one or more microprocessors or a combination of the DSP and a microprocessor. The communications unit 1303 may be a communications interface, a transceiver, a transceiver circuit, or the like. The communications interface is a general term, and may include one or more interfaces, for example, an interface between a first network device and a second network device, or an interface between an access network device and first user equipment, or an interface between an access network device and second user equipment. The storage unit 1301 may be a memory.

When the processing unit 1302 is a processor, the communications unit 1303 is a communications interface, and the storage unit 1301 is a memory, the network device in this embodiment of the present invention may be a network device shown in FIG. 13B.

Referring to FIG. 13B, the network device 1310 includes: a processor 1312, a communications interface 1313, and a memory 1311. In one embodiment, the network device 1310 may further include a bus 1314. The communications interface 1313, the processor 1312, and the memory 1311 may be connected to each other by using the bus 1314. The bus 1314 may be a peripheral component interconnect (PCI) bus, an extended industry standard architecture (EISA) bus, or the like. The bus 1314 may be classified into an address bus, a data bus, a control bus, and the like. For ease of denotation, the bus is indicated by using only one bold line in FIG. 13B. However, it does not indicate that there is only one bus or only one type of bus.

The network device shown in FIG. 13A or FIG. 13B may be an access network device, a first network device, or a second network device.

Methods or algorithm operations described with reference to the content disclosed in the embodiments of the present invention may be implemented by hardware, or may be implemented by a processor by executing a software instruction. The software instruction may include a corresponding software module. The software module may be stored in a random access memory (RAM), a flash memory, a read-only memory (ROM), an erasable programmable read-only memory (EPROM), an electrically erasable programmable read-only memory (EEPROM), a register, a hard disk, a mobile hard disk, a compact disc read-only memory (CD-ROM), or any other form of storage medium well-known in the art. For example, a storage medium is coupled to a processor, so that the processor can read information from the storage medium or write information into the storage medium. Certainly, the storage medium may be a component of the processor. The processor and the storage medium may be located in the ASIC. In addition, the ASIC may be located in a network device. Certainly, the processor and the storage medium may exist in the network device as discrete components.

A person skilled in the art should be aware that in the foregoing one or more examples, functions described in the embodiments of the present invention may be implemented by hardware, software, firmware, or any combination thereof. When the functions are implemented by software, the functions may be stored in a computer-readable medium or transmitted as one or more instructions or code in the computer-readable medium. The computer-readable medium includes a computer storage medium and a communications medium. The communications medium includes any medium that enables a computer program to be transmitted from one place to another. The storage medium may be any available medium accessible to a general purpose computer or a dedicated computer.

In the foregoing specific implementations, the objectives, technical solutions, and benefits of the embodiments of the present invention are further described in detail. It should be understood that the foregoing descriptions are merely specific implementations of the embodiments of the present invention, but are not intended to limit the protection scope of the embodiments of present invention. Any modification, equivalent replacement, or improvement made based on the technical solutions of the embodiments of the present invention shall fall within the protection scope of the embodiments of the present invention.

What is claimed is:

1. A method for implementing user equipment cooperation by an access network device, the method comprising:
generating, by the access network device, cooperative control information, wherein the cooperative control information is used to instruct a first user equipment to perform sidelink transmission in a first transmission unit of a first subframe and perform uplink transmission in a second transmission unit of the first subframe, the first transmission unit is adjacent to the second transmission unit, and the sidelink transmission comprises that the first user equipment sends feedback information to a second user equipment; and
sending, by the access network device, the cooperative control information to the first user equipment and the second user equipment.

2. The method according to claim 1, wherein the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, and the fourth transmission unit is prior to the first transmission unit.

3. The method according to claim 1, wherein the sending, by the access network device, the cooperative control information to the first user equipment and the second user equipment comprises:
sending, by the access network device, the cooperative control information to the first user equipment and the second user equipment in a fifth transmission unit of the first subframe, wherein the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, the fourth transmission unit is prior to the first transmission unit, and the fifth transmission unit is prior to the third transmission unit.

4. The method according to claim 1, wherein the sending, by the access network device, the cooperative control information to the first user equipment and the second user equipment comprises:
sending, by the access network device, the cooperative control information to the first user equipment and the second user equipment in a fifth transmission unit of the first subframe, wherein the cooperative control information is further used to instruct the second user equipment to send sidelink data to the first user equipment in a fourth transmission unit of the first subframe, the fourth transmission unit is prior to the first transmission unit, and the fifth transmission unit is prior to the fourth transmission unit.

5. The method according to claim 1, wherein the second transmission unit is a last transmission unit of the first subframe.

6. A method for implementing user equipment cooperation by a first user equipment, the method comprising:
receiving, by the first user equipment, cooperative control information sent by an access network device; and
performing, by the first user equipment, based on the cooperative control information, sidelink transmission in a first transmission unit of a first subframe and uplink transmission in a second transmission unit of the first subframe, wherein the first transmission unit is adjacent to the second transmission unit, and the sidelink transmission comprises that the first user equipment sends feedback information to a second user equipment.

7. The method according to claim 6, before the performing, by the first user equipment based on the cooperative control information, sidelink transmission in a first transmission unit of a first subframe and uplink transmission in a second transmission unit of the first subframe, the method further comprising:
receiving, by the first user equipment in a third transmission unit of the first subframe based on the cooperative control information, control information corresponding to sidelink data, and receiving the sidelink data in a fourth transmission unit of the first subframe based on the control information, wherein the third transmission unit is adjacent to the fourth transmission unit, the third transmission unit is prior to the fourth transmission unit, and the fourth transmission unit is prior to the first transmission unit.

8. The method according to claim 6, wherein the receiving, by the first user equipment, cooperative control information sent by an access network device comprises:
receiving, by the first user equipment in a fifth transmission unit of the first subframe, the cooperative control information sent by the access network device; and
before the performing, by the first user equipment based on the cooperative control information, sidelink transmission in a first transmission unit of a first subframe and uplink transmission in a second transmission unit of the first subframe, the method further comprising:
receiving, by the first user equipment in a third transmission unit of the first subframe based on the cooperative control information, control information corresponding to sidelink data, and receiving the sidelink data in a fourth transmission unit of the first subframe based on the control information, wherein the third transmission unit is adjacent to the fourth transmission unit, the third transmission unit is prior to the fourth transmission unit, the fourth transmission unit is prior to the first transmission unit, and the fifth transmission unit is prior to the third transmission unit.

9. The method according to claim 6, wherein the receiving, by the first user equipment, cooperative control information sent by an access network device comprises:
receiving, by the first user equipment in a fifth transmission unit of the first subframe, the cooperative control information sent by the access network device; and
before the performing, by the first user equipment based on the cooperative control information, sidelink transmission in a first transmission unit of a first subframe and uplink transmission in a second transmission unit of the first subframe, the method further comprising:
sending, by the second user equipment, sidelink data to the first user equipment in a fourth transmission unit of the first subframe based on the cooperative control information, wherein the fourth transmission unit is prior to the first transmission unit, and the fifth transmission unit is prior to the fourth transmission unit.

10. The method according to claim 6, wherein the second transmission unit is a last transmission unit of the first subframe.

11. An access network device, comprising a processing unit and a communications unit, wherein
the processing unit is configured to generate cooperative control information, wherein the cooperative control information is used to instruct a first user equipment to perform sidelink transmission in a first transmission unit of a first subframe and perform uplink transmission in a second transmission unit of the first subframe, the first transmission unit is adjacent to the second transmission unit, and the sidelink transmission comprises that the first user equipment sends feedback information to a second user equipment; and
the communications unit is configured to send the cooperative control information to the first user equipment and the second user equipment.

12. The access network device according to claim 11, wherein the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, and the fourth transmission unit is prior to the first transmission unit.

13. The access network device according to claim 11, wherein the communications unit is configured to:
send the cooperative control information to the first user equipment and the second user equipment in a fifth transmission unit of the first subframe, wherein the cooperative control information is further used to instruct the second user equipment to send, to the first user equipment in a third transmission unit of the first subframe, control information corresponding to sidelink data, and send the sidelink data to the first user equipment in a fourth transmission unit of the first subframe, the third transmission unit is adjacent to the fourth transmission unit, the third transmission unit is prior to the fourth transmission unit, the fourth transmission unit is prior to the first transmission unit, and the fifth transmission unit is prior to the third transmission unit.

14. The access network device according to claim 11, wherein the communications unit is configured to:
send the cooperative control information to the first user equipment and the second user equipment in a fifth transmission unit of the first subframe, wherein the cooperative control information is further used to instruct the second user equipment to send sidelink data to the first user equipment in a fourth transmission unit of the first subframe, the fourth transmission unit is prior to the first transmission unit, and the fifth transmission unit is prior to the fourth transmission unit.

15. The access network device according to claim 11, wherein the second transmission unit is a last transmission unit of the first subframe.

16. A first user equipment comprising a communications unit, wherein
the communications unit is configured to receive cooperative control information sent by an access network device; and
the communications unit is further configured to perform, based on the cooperative control information, sidelink transmission in a first transmission unit of a first subframe and uplink transmission in a second transmission unit of the first subframe, wherein the first transmission unit is adjacent to the second transmission unit, and the sidelink transmission comprises that the first user equipment sends feedback information to a second user equipment.

17. The first user equipment according to claim 16, wherein before the communications unit performs, based on the cooperative control information, the sidelink transmission in the first transmission unit of the first subframe and the uplink transmission in the second transmission unit of the first subframe, the communications unit is further configured to:
receive, in a third transmission unit of the first subframe based on the cooperative control information, control information corresponding to sidelink data, and receive the sidelink data in a fourth transmission unit of the first subframe based on the control information, wherein the third transmission unit is adjacent to the fourth transmission unit, the third transmission unit is prior to the fourth transmission unit, and the fourth transmission unit is prior to the first transmission unit.

18. The first user equipment according to claim 16, wherein the communications unit is configured to:
receive, in a fifth transmission unit of the first subframe, the cooperative control information sent by the access network device; and
before the communications unit performs, based on the cooperative control information, the sidelink transmission in the first transmission unit of the first subframe and the uplink transmission in the second transmission unit of the first subframe, the communications unit is further configured to:
receive, in a third transmission unit of the first subframe based on the cooperative control information, control information corresponding to sidelink data, and receive the sidelink data in a fourth transmission unit of the first subframe based on the control information, wherein the third transmission unit is adjacent to the fourth transmission unit, the third transmission unit is prior to the fourth transmission unit, the fourth transmission unit is prior to the first transmission unit, and the fifth transmission unit is prior to the third transmission unit.

19. The first user equipment according to claim 16, wherein the communications unit is configured to:
receive, in a fifth transmission unit of the first subframe, the cooperative control information sent by the access network device; and
before the communications unit performs, based on the cooperative control information, the sidelink transmission in the first transmission unit of the first subframe and the uplink transmission in the second transmission unit of the first subframe, the communications unit is further configured to:
send sidelink data to the first user equipment in a fourth transmission unit of the first subframe based on the cooperative control information, wherein the fourth transmission unit is prior to the first transmission unit, and the fifth transmission unit is prior to the fourth transmission unit.

20. The first user equipment according to claim 16, wherein the second transmission unit is a last transmission unit of the first subframe.
